(19) United States
(12) Patent Application Publication
(10) Pub. No.: US 2026/0104699 A1
(43) Pub. Date: Apr. 16, 2026

(54) Monitoring An Operability Of A Production System

(71) Applicant: Siemens Industry Software Inc., Plano, TX (US)

(72) Inventors: Jan Fischer, München (DE); Wolfram Klein, Neubiberg (DE); Annelie Sohr, München (DE); Franz Georg Listl, Pettendorf (DE); Johannes Frank, Meerbusch (DE); Stephan Grimm, München (DE); Janaki Joshi, Vaterstetten (DE); Kai Liu, Heroldsberg (DE)

(73) Assignee: Siemens Industry Software Inc., Plano, TX (US)

(21) Appl. No.: 19/116,254

(22) PCT Filed: Sep. 29, 2022
(86) PCT No.: PCT/EP2022/077199

§ 371 Date: Mar. 27, 2025

(51) Int. Cl. G05B 23/02

(52) U.S. Cl. CPC G05B 23/0243; G05B 23/0229

(57) ABSTRACT

An apparatus comprising: an input unit to receive production-related data of the production system; a mapping engine to map the production-related data to instance data of a first knowledge graph according to a given mapping definition; a first validation unit to validate a consistency and/or an integrity of the instance data using declarative constraints and to output a first validation result; a simulator to generate a computer-implemented material flow simulation model of the production system based on the instance data and depending on the first validation result; a generator to generate simulated production logs using the material flow simulation model; a second validation unit to validate the simulated production logs against measured production logs of the production system and to output a second validation result; and an output unit to output the second validation result for monitoring the operability of the production system.

### CROSS-REFERENCE TO RELATED APPLICATIONS

This application is a U.S. National Stage Application of International Application No. PCT/EP2022/077199 filed Sep. 29, 2022, which designates the United States of America, the contents of which are hereby incorporated by reference in their entirety.

### TECHNICAL FIELD

The present disclosure relates to production systems. Various embodiments of the teachings herein include apparatus and methods for monitoring an operability of a production system.

### BACKGROUND

Material flow simulations provide great benefit as for example decision support systems and/or operability monitoring systems when being used during the operation phase of production systems. Computer simulation models can be generated from various data sources in an enterprise by means of some automated processing pipeline. However, often the generation and synchronization of the simulation model is quite cumbersome since many different and heterogeneous data sources from the production system need to be considered. Often these raw data sources contain information and data elements that are not required, not updated, inconsistent with each other and thus need to be integrated, transformed, and/or validated before being used for the simulation model generation. Especially the validation and/or consistency checking often takes time. Often inconsistencies are only detected piece by piece during the modeling process which requires frequent exchange meetings between simulation experts and factory experts and development iterations of the simulation model. In the worst case, inconsistencies are detected during the productive use of simulation or not even at all, resulting in erroneous simulation results.

### SUMMARY

Teachings of the present disclosure may improve the data validation of a production system for monitoring an operability of the production system. For example, some embodiments of the teachings herein include an apparatus for monitoring an operability of a production system, the apparatus comprising: an input unit configured to input production-related data of the production system, a mapping engine configured to map the production-related data to instance data of a first knowledge graph according to a given mapping definition, a first validation unit configured to validate a consistency and/or an integrity of the instance data by means of declarative constraints and to output a first validation result, a simulator configured to generate a computer-implemented material flow simulation model of the production system based on the instance data and depending on the first validation result, a generator configured to generate simulated production logs using material flow simulation model, a second validation unit configured to validate the simulated production logs against measured production logs of the production system and to output a second validation result, and an output unit configured to output the second validation result for monitoring the operability of the production system.

As another example, some embodiments include a computer-implemented method for monitoring an operability of a production system, the method comprising: inputting production-related data of the production system, mapping the production-related data to instance data of a first knowledge graph according to a given mapping definition, validating a consistency and/or an integrity of the instance data by means of declarative constraints and to output a first validation result, generating a computer-implemented material flow simulation model of the production system based on the instance data and depending on the first validation result, generating simulated production logs using the material flow simulation model, validating the simulated production logs against measured production logs of the production system and to output a second validation result, and outputting the second validation result for monitoring the operability of the production system.

### BRIEF DESCRIPTION OF THE DRAWINGS

The teachings of the present disclosure are explained in more detail by reference to the accompanying figures.

FIG. 1: shows an example apparatus for monitoring an operability of a production system incorporating teachings of the present disclosure; and

FIG. 2: shows an example computer-implemented method for monitoring an operability of a production system incorporating teachings of the present disclosure.

Equivalent parts in the different figures are labeled with the same reference signs.

### DETAILED DESCRIPTION

The present disclosure describes an integrated use of an explicit representation of simulation relevant data in a uniform and reusable knowledge graph as a basis for a constraint catalogue that allows the automatic use of for example predefined SHACL validation constraints to factory instance data of this knowledge graph. Furthermore, after validation of the production-related data, simulation models can be automatically generated. Then, scenarios based on factory data instances and the further application of predefined SHACL validation constraints provide a comparison of the real production data with the simulated data for checking the operability of the production system. By validating the input data and generating the simulation model depending on the validation result, the simulation can be used to generate simulated production logs that can then be compared to measured production logs, therefore, allowing to monitor the operability of the production system.

Using these teachings may reduce the effort for the validation of raw production-related data required for plant simulation models during operation and therefore also their generation and application by using declarative constraints, like e.g., SHACL constraints, for checking the data consistency of raw data required for material flow models. Data inconsistencies can be easily detected. Therefore, material flow simulations can be more easily generated to compare simulated data with measured data from the production. This allows efficient monitoring of the production system during the operation leading to more benefits such as optimization of production KPIs like throughput, utilization rate, efficiency etc.

Additionally, by using a knowledge graph or graph data model as a common representation, the effort for onboarding new data sources or extending the data model by additional concepts is minimized, i.e., it is less time-consuming, less error-prone, more maintainable, and therefore more cost-effective.

In some embodiments, the apparatus can further comprise a storage unit configured to store the simulated logs and/or the measured logs a second knowledge graph. This allows straightforward comparison of the simulated with the measured data logs. The storage unit can be further configured to map or transform the simulated logs/log-files and/or the measured logs/log-files to instance log-data of the second knowledge graph.

In some embodiments, the second validation unit can be configured to validate the simulated production logs against the measured production logs by means of declarative constraints. Declarative constraints can be understood to provide predefined rules for checking respective data. Therefore, data checks and/or comparisons can be automated.

In some embodiments, the declarative constraints can be based on the Shapes Constraint Language (SHACL).

In some embodiments, the declarative constraints can be based on the SPARQL Query Language.

In some embodiments, the production-related data can comprise production orders, a bill of processes, a bill of resources, and/or production events.

In some embodiments, the production-related data can be checked depending on the first validation result. The first validation result provides information about the consistency and/or integrity of the production-related data. Therefore, the first validation result can for example summarize violations within the instance data. In case of a violation, the original production-related data can be checked and for example reloaded or requested again. The validation result can for example be exported as a report for an expert to notify about issues in the source data.

Some embodiments of the teachings herein include a computer program product (non-transitory computer readable storage medium having instructions, which when executed by a processor, perform actions) having program instructions for performing one or more of the methods described herein.

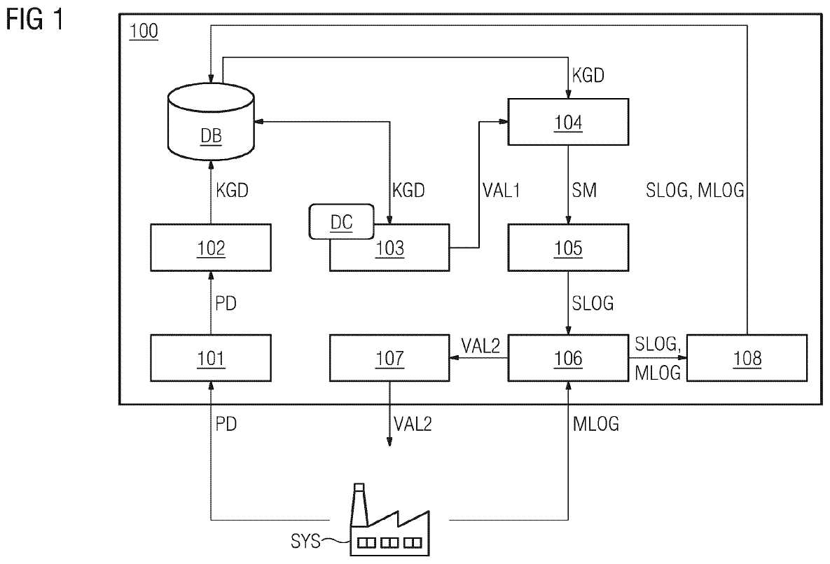

FIG. 1 shows an example apparatus 100 for monitoring an operability of a production system SYS incorporating teachings of the present disclosure. A production system SYS can be for example an automated factory for producing or manufacturing a product. The apparatus 100 can comprise software and/or hardware components. In particular, the apparatus 100 can comprise at least one processor. The apparatus 100 may be coupled with the production system SYS, e.g., to exchange data for monitoring the production system SYS. In some embodiments, the apparatus 100 is configured to generate and run a computer-aided simulation of the production system, e.g., in parallel to the operation of the production system, to monitor the operability, e.g. productivity, efficiency, performance, and/or functionality, of the production system SYS by comparing simulated with measured production logs.

The apparatus 100 comprises components to monitor production-related data of the production system to allow conclusions about the operability of the production system SYS. For example, the apparatus 100 can provide information about performance of production lines, production progress, status of production etc. based on production logs of the production system. Such information gives insight into the operability of the production system, i.e., whether the production system works as specified.

The apparatus 100 comprises an input unit 101, a mapping engine 102, a first validation unit 103, a simulator 104, a generator 105, a second validation unit 106, and an output unit 107. Furthermore, the apparatus 100 can comprise a storage unit 108. All these units/components are preferably connected with each other to exchange data.

The input unit 101 is configured to input production-related data PD of the production system SYS. The production-related data can be raw data from different and/or heterogenous data sources related to the production system SYS. Data sources can be for example Enterprise Resource Planning (ERP) Systems, Manufacturing Execution Systems (MES), file-based data (Excel, CSV, . . . ) or other Engineering Tools (CAD, Layout Designer, . . . ). The production-related data PD can comprise production orders, a bill of processes, a bill of resources, and/or production events. The production-related data PD are preferably provided in machine-readable formats, e.g., Excel, CSV files, etc. The production-related data PD are provided to the mapping engine 102.

The mapping engine 102 is configured to map the production-related data PD to instance data KGD of a first knowledge graph model according to a given mapping definition. Mapping the production-related data PD to instance data KGD can in particular involve selecting required parts of the production-related data PD and/or transforming the production-related data PD to a data format that is required by knowledge graph. The mapping definition comprises rules for mapping the data to the knowledge graph according to a predefined schema.

In other words, the mapping engine maps the raw data to graph instance data (e.g., RDF) that is aligned with the reusable schema f a knowledge graph model. For the mapping engine 102 existing technologies can be used, e.g., OpenRefine, OntoRefine, RMLMapper. A mapping definition, that defines how the raw data is mapped to graph instance data can be provided per data source in a descriptive manner depending on the chosen technology for the mapping engine 102, e.g., General Refine Expression Language (GREL) or RDF Mapping Language (RML).

The instance data KGD can be sent to and stored in the graph database DB. The instance data KGD can then be retrieved from the graph database DB by other units. In some embodiments, the instance data KGD can be provided to the respective other units.

The first validation unit 103 is configured to validate a consistency and/or an integrity of the instance data KGD by means of declarative constraints DC and to output a first validation result VAL1. The declarative constraints DC can be for example based on the Shapes Constraint Language (SHACL) or on the SPARQL Query Language.

The first validation unit 103 validates the instance data KGD in the graph database by performing consistency and integrity checks. The first validation unit 103 is preferably backed by a catalog of validation rules, constraints, and/or conditions. Hence, by applying for example such validation rules, constraints and/or conditions, the consistency and integrity of the instance data KGD can be checked. These validation constraints can be provided by means of e.g., SPARQL queries or SHACL shapes. The catalog can contain a default set of validation rules that is applicable generically to every use Case as well as a set of user-provided rules and constraints that can be use-case/customer specific.

The first validation result VAL1 can be output, e.g., for checking the production-related data PD. The first validation result VAL1 can be for example exported as part of a report comprising information about the consistency and/or integrity of the input data PD.

Depending on the validation result VAL1, the instance data KGD can be provided to the simulator 104. For example, if the validation result VAL1 provides no violation of the consistency and/or integrity of the instance data KGD within a given uncertainty range, the instance data KGD can be retrieved by the simulator 104.

The simulator 104 is configured to generate a computer-implemented material flow simulation model SM of the production system SYS based on the instance data KGD and depending on the first validation result VAL1. Therefore, if the production data are correct and consistent within the given uncertainty range, the simulator 104 automatically generates the simulation model SM using the master data (e.g., Machines, Orders, Products) from graph database DB.

Based on the generated material flow simulation model SM, the generator 105 is configured to generate simulated production logs/log-files SLOG. In some embodiments, the generator creates simulated production logs SLOG by using the generated material flow simulation model SM and a subset of given production orders and/or other dynamically changing data elements (e.g., the availability of the workers and machines as well as the current status of the production). Simulated logs SLOG typically comprise the start and end time of production processes (process steps), the order and product they belong to and the resource where the process was executed on. Sometimes also more information like the personnel involved or additional tools and equipment is added.

The simulated production logs/log-files SLOG as well as respective measured logs/log-files MLOG can then be uploaded to the graph database DB. The measured logs MLOG can be provided for example by sensors of the production system SYS. Preferably, the measured production logs MLOG correspond to the simulated production logs SLOG in e.g., time range of production process etc. In particular, the storage unit 108 is configured to store the simulated logs SLOG and/or the measured logs MLG in a second knowledge graph. Therefore, the storage unit 108 can be configured as a mapping engine for mapping the simulated logs SLOG and/or the measured logs MLOG to graph data of a second knowledge graph.

Then, the second validation unit 106 validates the simulated production logs SLOG against the measured production logs MLOG by means of declarative constraints. In some embodiments, the simulated production logs SLOG are validated against the measured production MLOG by means of SHACL or SPARQL constraints applied to the second knowledge graph.

The second validation unit 106 provides a second validation result VAL2 comprising information about deviations of the measured production logs MLOG from the simulated production logs SLOG. For example, the second validation result VAL2 can comprise information about no deviation between simulated and measured production logs, pointing out full operability of the production system SYS. In some embodiments, the second validation result can comprise information about specific deviations of the measured production logs MLOG from the simulated production logs, pointing out possible production failures or problems.

The second validation result VAL2 is provided by the output unit 107 to a user and/or to the production system SYS and can be used for monitoring the operability of the production system SYS. For example, based on the second validation result VAL2, the production can be continued or at least partially stopped or interrupted. Therefore, it is possible to provide the second validation result VAL2 to a control unit of the production system SYS for controlling the production system SYS depending on the second validation result VAL2. For example, in case of an inconsistency between the measured production logs MLOG and the simulated production logs SLOG, the production system SYS or the affected part of the production system SYS can be stopped or decelerated.

In some embodiments, the apparatus 100 can process production-related data as described above in iterative steps for predefined time spans. This allows continuous monitoring of the production system SYS.

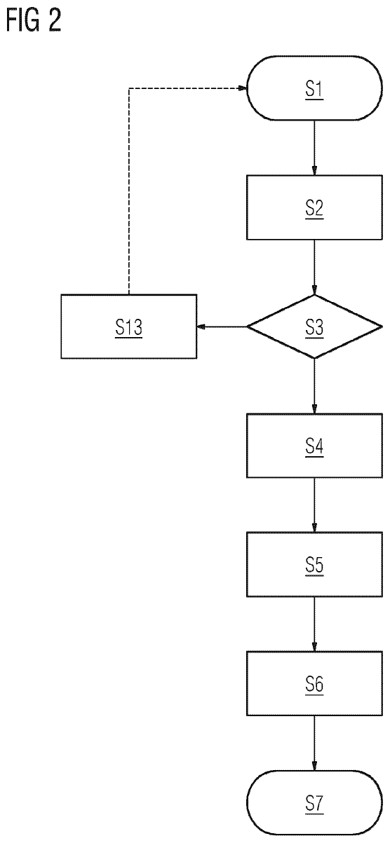

FIG. 2 shows an example computer-implemented method for monitoring the operability of a production system incorporating teachings of the present disclosure. The method can be for example performed by an apparatus as described in FIG. 1.

In a first step S1, production-related data of the production system can be input, e.g., read in from data sources connected with the production system.

In the next step S2, the production-related data are mapped to instance data of a first knowledge graph according to a given mapping definition. Therefore, the production-related data are assigned to the knowledge graph according to a predefined mapping definition.

In the next step S3, a consistency and/or an integrity of the instance data is validated by means of declarative constraints, e.g., SHACL or SPARQL constraints, and a first validation result is provided.

In case of a positive first validation result, i.e., consistent and valid instance data according to the first validation, in the next step S4 a computer-implemented material flow simulation model of the production system can be generated based on the instance data.

In case of a negative first validation result, i.e., for example inconsistent instance data, the first validation result is provided, step 13. It is then possible to further check the instance data/the production-related data and for example request new/updated production-related data and repeat steps S1 to S3.

In the next step S5, in case of a positive first validation result, simulated production logs are generated using the material flow simulation model. The simulated production logs can then be stored in a second knowledge graph. In addition, measured production logs from the production systems can be retrieved and also stored in the second knowledge graph.

In the next step S6, the simulated production logs are validated against measured production logs using declarative constraints, e.g., SHACL or SPARQL constraints, and a second validation result is provided.

In the next step S7, the second validation result is provided for monitoring the operability of the production system.

All of the described and/or drawn features as shown by the embodiments can be advantageously combined. Although the present disclosure has been described in detail with reference to example embodiments, the present disclosure is not limited by the disclosed examples, and that numerous additional modifications and variations could be made thereto by a person skilled in the art without departing from the scope thereof.

What is claimed is:

1. An apparatus for monitoring operability of a production system, the apparatus comprising:
an input unit to input production-related data of the production system;
a mapping engine to map the production-related data to instance data of a first knowledge graph according to a given mapping definition;
a first validation unit to validate a consistency and/or an integrity of the instance data using declarative constraints and to output a first validation result;
a simulator to generate a computer-implemented material flow simulation model of the production system based on the instance data and depending on the first validation result;
a generator to generate simulated production logs using the material flow simulation model;
a second validation unit to validate the simulated production logs against measured production logs of the production system and to output a second validation result; and
an output unit to output the second validation result for monitoring the operability of the production systems.

2. An apparatus according to claim 1, further comprising a storage unit to store the simulated logs and/or the measured logs in a second knowledge graph.

3. An apparatus according to claim 2, wherein the second validation unit validates the simulated production logs against the measured production logs using declarative constraints.

4. An apparatus according to claim 1, wherein the declarative constraints are based on Shapes Constraint Language.

5. An apparatus according to claim 1, wherein the declarative constraints are based on SPARQL Query Language.

6. An apparatus according to claim 1, wherein the production-related data comprise production orders, a bill of processes, a bill of resources, and/or production events.

7. An apparatus according to claim 1, wherein the production-related data are checked depending on the first validation result.

8. A method for monitoring an operability of a production system, the method comprising:
entering production-related data of the production system;
mapping the production-related data to instance data of a first knowledge graph according to a given mapping definition;
validating a consistency and/or an integrity of the instance data using declarative constraints and generating a first validation result;
generating a computer-implemented material flow simulation model of the production system based on the instance data and depending on the first validation result;
generating simulated production logs using the material flow simulation model;
validating the simulated production logs against measured production logs of the production system and generating a second validation result; and
transmitting the second validation result for monitoring the operability of the production system.

9. (canceled)
